(19) United States
(12) Patent Application Publication
(10) Pub. No.: US 2011/0123475 A1
(43) Pub. Date: May 26, 2011

(54) COATING COMPOSITION COMPRISING AN ANTIMICROBIAL COPOLYMER

(76) Inventors: Aylvin J.A.A. Dias, Maastricht (NL); Jacobus A. Loontjens, Meerssen (NL)

(21) Appl. No.: 12/918,138

(22) PCT Filed: Feb. 18, 2009
(86) PCT No.: PCT/EP2009/051889

§ 371 Date: Nov. 15, 2010

(30) Foreign Application Priority Data
Feb. 18, 2008 (EP) 08151574.4

(51) Int. Cl. A01N 43/36; A01P 1/00; C08L 39/06; B32B 1/08; B32B 5/02

(52) U.S. Cl. 424/78.3; 524/548; 428/36.91; 428/375; 442/1

(57) ABSTRACT

The invention relates to a coating composition comprising an antimicrobial hydrophilic copolymer consisting of a macromer and a comonomer, the use of said coating composition in medical applications and, in particular in a medical device and to a medical device comprising the coating composition, preferably selected from catheters, endoscopes, laryngoscopes, tubes for feeding or drainage or endotracheal use or oesophageal use. The coating composition can further comprise a hydrophilic polymer, a polyelectrolyte and a photo-initiator.

The invention relates to a coating composition comprising an antimicrobial copolymer, the use of said coating composition in medical applications and, in particular in a medical device and to a medical device comprising the coating composition.

Infections that arise as a result of temporary or permanent implants are some of the most serious and frequent sources of complications that arise from the use of invasive medical devices. During the implantation or insertion procedure of medical articles like hip and knee implants, pacemaker leads, meshes, catheters and vascular devices the mucosal or endothelial or indeed any biological counter surface is often damaged, resulting in microbial infections. Thus in the drive to minimise microbial infections it is important to provide a medical device with antimicrobial properties.

Medical devices, such as medical implants, are often provided with hydrophilic coatings, as such coatings feature low absorption of cellular species. Hydrophilic coatings usually comprise a hydrophilic polymer to provide the hydrophilicity, as described in for example WO2006/056482, WO2007/065720, WO2007/065721, and WO2007/065722. Usually a polymer is used that is suitable to provide a lubricious hydrophilic coating. In particular suitable are polymers that are polymerisable, graftable and/or cross-linkable in the presence of a photo-initiator.

Medical devices, for example coatings on medical devices, can be provided with antimicrobial properties by adding antimicrobial agents, as disclosed in several publications. Usually antimicrobial agents, such as silver, quaternary ammonium compounds etc. are added as separate (low molecular) compounds. A disadvantage of this approach is that the antimicrobial agent is not fixed in the medical device and can leach out to the surface of the device, whereby the antimicrobial properties of the device deteriorate.

The aim of the invention is therefore to provide a medical device, in particular a hydrophilic coating on a medical device, comprising an antimicrobial agent that does not leach out to the surface of the device, or at least leaches out to a lesser extent.

This can be achieved according to the present invention by providing a coating composition that comprises a hydrophilic copolymer comprising at least one antimicrobial group, in particular a quaternary ammonium group.

The coating composition comprises an antimicrobial hydrophilic copolymer consisting of a macromer according to Formula 1,

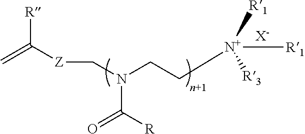

wherein R and R′ independently represent H or a group selected from substituted and unsubstituted hydrocarbons which optionally contain one or more heteroatoms, preferably a C1-C20 hydrocarbon, more preferably a C1-C20 alkyl or aryl, R″ is H or CH₃, Z is benzyl, CO or

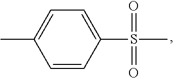

X═I, Br, Cl, CF₃SO₃, C₆H₄SO₃, n=1-100 and a comonomer.

The macromer according to formula 1 is made by, for example, reacting vinylbenzylchloride with an oxazoline, and subsequently reacting the intermediate with a tertiary amine as shown below:

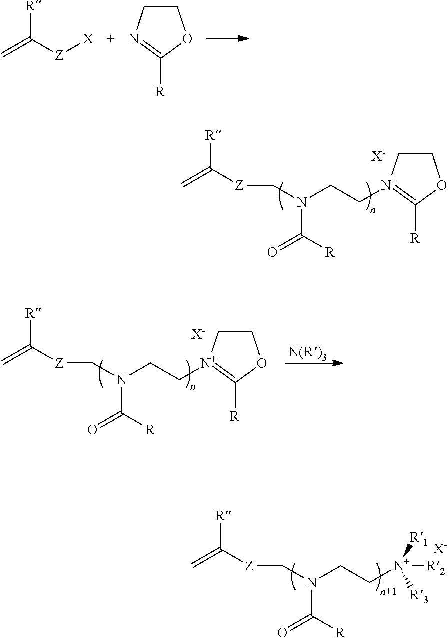

The antimicrobial hydrophilic copolymer can be prepared by reacting the macromers as described here above with a comonomer. Preferred are comonomers that provide hydrophilicity to the copolymer. Examples of suitable comonomers are vinyl lactams, in particular vinylpyrrolidones; urethanes; acrylic and methacrylic acid; vinyl alcohols; vinylethers; maleic anhydride; vinyl esters; vinyl amines; ethylene imines; ethylenically unsaturated carboxylic acids, amides, anhydrides, phosphazenes, cellulosics, in particular ethylenically unsaturated methyl cellulose, carboxymethyl cellulose, hydroxymethylcellulose, hydroxypropylcellulose and other saccharides, in particular chitosans, hyaluronic acids, alginates, gelatins, chitins, heparins, dextrans; chondroit ethylenically unsaturated sulphates; esters, in particular lactides, glycolides, caprolactones and nucleotides.

The antimicrobial hydrophilic copolymer is particularly suitable for the use in antimicrobial coatings as it provides a spacer between the quaternary ammonium salt and the polymer backbone. According to Klibanov (PNAS, 103, no. 47. 17667, (2006)) this is essential in order to exploit fully the efficacy of quaternary ammonium compounds. In the above method the spacer length can be varied in a controlled manner by using a living polymerization technology. Oxazolines are particularly suitable to be polymerized in a living way, with as a result that the length of spacer can be adjusted at will. The polyoxazoline spacers in the antimicrobial hydrophilic copolymers, are highly water soluble, which is needed to keep the adhesion of microorganism as low as possible. Hence, antimicrobial hydrophilic copolymers can be prepared containing various amounts of monomers comprising quaternary ammonium groups, with and without spacers between the quaternary ammonium unit and the polymer backbone. The length of the spacer is an important tool to tailor the antibacterial properties.

The anti-microbial copolymer is applied in a coating composition, preferably a hydrophilic coating composition. In particular, the coating composition may be used for medical applications, more in particular in the manufacture of a coating composition to reduce the risk of infections, for example catheter associated infections, such as catheter associated urinary tract infections and catheter associated blood stream infections, or for the treatment of a disorder selected from the group consisting of complications of the urinary tract, complications of a cardiovascular vessel, kidney infections, blood infections (septicaemia), urethral injury, skin breakdown, bladder stones and hematuria or to prevent infections.

The invention further relates to the use of a coating composition according to the invention or a coating obtainable by curing a coating composition according to the invention to reduce bacterial adhesion or to act as an antimicrobial agent. The coating composition or coating may be used in vitro or in vivo.

The term “(co)polymer” is used herein for a molecule comprising two or more repeating units. In particular it may be composed of two or more monomers which may be the same or different. As used herein, the term includes oligomers and prepolymers. Usually polymers have a number average weight of about 500 g/mol or more, in particular of about 1000 g/mol or more, although the molar mass may be lower in case the polymer is composed of relatively small monomeric units and/or the number of units is relatively low. The term polymer includes oligomers. A polymer is considered an oligomer if it has properties which do vary significantly with the removal of one or a few of the units.

The term “to cure” includes any way of treating the coating composition such that it forms a firm or solid coating. In particular, the term includes a treatment whereby the hydrophilic polymer further polymerises, is provided with grafts such that it forms a graft polymer and/or is cross-linked, such that it forms a cross-linked polymer.

In line with common practice, when referred to “a” moiety or “the” moiety (e.g. a compound for instance a (hydrophilic) polymer, a polyelectrolyte, an initiator) this is meant to refer to one or more species of said moiety.

Within the context of the invention a coating on the (outer) surface of a medical device, such as a catheter, is considered lubricious if (when wetted) it can be inserted into the intended body part without leading to injuries and/or causing unacceptable levels of pain to the subject. In particular, a coating is considered lubricious if it has a friction as measured on a Harland FTS Friction Tester of 20 g or less at a clamp-force of 300 g and a pull speed of 1 cm/s, preferably of 15 g or less.

The term “wetted” is generally known in the art and—in a broad sense—means “containing water”. In particular the term is used herein to describe a coating that contains sufficient water to be lubricious. In terms of the water concentration, usually a wetted coating contains at least 10 wt. % of water, based on the dry weight of the coating, preferably at least 50 wt. %, based on the dry weight of the coating, more preferably at least 100 wt. % based on the dry weight of the coating. For instance, in a particular embodiment of the invention a water uptake of about 300-500 wt. % water is feasible.

Within the context of the invention, the dry-out time is the duration of the coating remaining lubricious after the device has been taken out of the wetting fluid wherein it has been stored/wetted. Dry-out time can be determined by measuring the friction in gram as a function of time the catheter had been exposed to air (22° C., 35% RH) on the Harland Friction tester. The dry-out time is the point in time wherein the friction reaches a value of 20 g or higher, or in a stricter test 15 g or higher.

The inventors have realised that providing a coating making use of a photo-initiator is advantageous in that it allows the coating of articles comprising a material that is not sufficiently thermally stable to allow thermal curing and/or drying at an elevated temperature.

The inventors further contemplate that also for coating an article which is thermally stable, thermal curing/drying may be disadvantageous. It is contemplated that as a result of the heating, one or more additives in the article—in particular one or more plasticizers may migrate to the surface of the article, possibly even into or through the coating, thereby affecting a property of the coating and/or leading to medical complications, in case the article is inside a patient's body or in contact therewith. For instance, blooming may occur as a result of migration of a plasticizer to the surface of the article. As a coating composition may also be used to provide a coating without needing elevated temperature, such risk is avoided or at least reduced in a method of the invention.

It is further contemplated that the photo-curing provides an advantageous polymer network, in particular such network comprising grafts and/or cross-links, with good lubricity and/or wear resistance.

The coating composition according to the invention therefore preferably further comprises an initiator, more preferably a photo-initiator. As a photo-initiator, in principle any photo-initiator can be used that is suitable to cure the coating composition in the presence of electromagnetic radiation, in particular UV, visible or IR light.

Particularly suitable is a photo-initiator that is soluble in a carrier liquid that is used in the coating composition according to the invention, at the concentration wherein the initiator is present in the coating composition.

Particularly suitable is a photo-initiator, capable of performing a photochemical homolytic bond cleavage, such as a Norrish type I cleavage reaction, or a heterolytic bond cleavage, in particular a Norrish type II cleavage.

Norrish Type I photo-initiators cause homolytic cleavage of the chromophore directly to generate radicals that initiate polymerization. Norrish Type II photo-initiators generate radicals indirectly by hydrogen abstraction from a suitable synergist, e.g. a tertiary amine. More in detail: free-radical photo-initiators are generally divided into two classes according to the process by which the initiating radicals are formed. Compounds that undergo unimolecular bond cleavage upon irradiation are termed Norrish Type I or homolytic photo-initiators, as shown by formula (1):

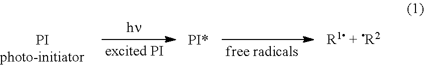

Depending on the nature of the functional group and its location in the molecule relative to the carbonyl group, the fragmentation can take place at a bond adjacent to the carbonyl group (α-cleavage), at a bond in the β-position (β-cleavage) or, in the case of particularly weak bonds (like C—S bonds or O—O bonds), elsewhere at a remote position. The most important fragmentation in photo-initiator molecules is the α-cleavage of the carbon-carbon bond between the carbonyl group and the alkyl residue in alkyl aryl ketones, which is known as the Norrish Type I reaction.
If the excited state photo-initiator interacts with a second molecule (a co-initiator COI) to generate radicals in a bimolecular reaction as shown by formula (2), the initiating system is termed a Type II photo-initiator. In general, the two main reaction pathways for Type II photo-initiators are hydrogen abstraction by the excited initiator or photo-induced electron transfer, followed by fragmentation. Bimolecular hydrogen abstraction is a typical reaction of diaryl ketones. Photo-induced electron transfer is a more general process, which is not limited to a certain class of compounds.

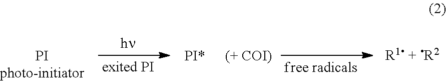

Examples of suitable Type I or cleavage free-radical photo-initiators are benzoin derivatives, methylolbenzoin and 4-benzoyl-1,3-dioxolane derivatives, benzylketals, α,α-dialkoxyacetophenones, α-hydroxy alkylphenones, α-aminoalkylphenones, acylphosphine oxides, bisacylphosphine oxides, acylphosphine sulphides, halogenated acetophenone derivatives, and the like. Commercial examples of suitable Type I photo-initiators are Irgacure 2959 (2-hydroxy-4′-(2-hydroxyethoxy)-2-methylpropiophenone), Irgacure 651 (benzildimethyl ketal or 2,2-dimethoxy-1,2-diphenylethanone, Ciba-Geigy), Irgacure 184 (1-hydroxy-cyclohexyl-phenyl ketone as the active component, Ciba-Geigy), Darocur 1173 (2-hydroxy-2-methyl-1-phenylpropan-1-one as the active component, Ciba-Geigy), Irgacure 907 (2-methyl-1-[4-(methylthio)phenyl]-2-morpholino propan-1-one, Ciba-Geigy), Irgacure 369 (2-benzyl-2-dimethylamino-1-(4-morpholinophenyl)-butan-1-one as the active component, Ciba-Geigy), Esacure KIP 150 (poly {2-hydroxy-2-methyl-1-[4-(1-methylvinyl)phenyl]propan-1-one}, Fratelli Lamberti), Esacure KIP 100 F (blend of poly {2-hydroxy-2-methyl-1-[4-(1-methylvinyl)phenyl]propan-1-one} and 2-hydroxy-2-methyl-1-phenyl-propan-1-one, Fratelli Lamberti), Esacure KTO 46 (blend of poly {2-hydroxy-2-methyl-1-[4-(1-methylvinyl)phenyl]propan-1-one}, 2,4,6-trimethylbenzoyldiphenyl-phosphine oxide and methylbenzophenone derivatives, Fratelli Lamberti), acylphosphine oxides such as Lucirin TPO (2,4,6-trimethylbenzoyl diphenyl phosphine oxide, BASF), Irgacure 819 (bis(2,4,6-trimethylbenzoyl)-phenyl-phosphine-oxide, Ciba-Geigy), Irgacure 1700 (25:75% blend of bis(2,6-dimethoxybenzoyl)2,4,4-trimethyl-pentyl phosphine oxide and 2-hydroxy-2-methyl-1-phenyl-propan-1-one, Ciba-Geigy), and the like. Also mixtures of type I photo-initiators can be used. For colored (e.g. pigmented) systems, phosphine oxide type photo-initiators and Irgacure 907 are preferred.

Preferred photo-initiators are soluble in the carrier liquid or can be adjusted to become soluble in the carrier liquid. Also preferred photo-initiators are polymeric or polymerizable photo-initiators.

Good results have been achieved with a Norrish type II initiator. Particular good results have been achieved with benzophenone. Other examples of suitable initiators include hydroxymethylphenylpropanone, dimethoxyphenylacetophenone, 2-methyl-l-4-(methylthio)-phenyl-2-morpholino-propanone-1,1-(4-isopropylphenyl)-2-hydroxy-2-methylpropan-1-one, 1-(4-dodecyl-phenyl)-2-hydroxy-2-methylpropan-1-one, diethoxyphenyl acetophenone, and the like. Phosphine oxide photoinitator types (e.g., Lucirin TPO by BASF) such as benzoyl diaryl phosphine oxide photo-initiators may be used.

The concentration of the photo-initiator can be determined based upon the efficiency of the initiator, the desired degree of polymerization and the amount of polymer (i.e. the hydrophilic polymer, if present the cross-linker and if present the polymeric polyelectrolyte).

Usually, the total initiator concentration is up to 10 wt. %, based on the total weight of the polymer. In particular in case a high dry-out time and/or high lubricity are desired, preferably a relatively low amount of photo-initiator is used, in particular an amount of up to 5 wt. %, more in particular of up to 4 wt. %. Particularly good results have been achieved with an amount of about 2 wt. % or less, for instance about 1 wt. %.

Usually the concentration is at least 0.1 wt. %, based on the weight of the polymer. For improved adhesion to the surface of the article and/or for a low amount of extractables, a relatively high concentration may be desired, in particular of at least 0.5 wt. %, more in particular of at least 1.0 wt. %, based on the weight of the polymer.

Optionally, the coating composition according to the invention may comprise a further hydrophilic polymer which is different from the anti-microbial hydrophilic copolymer. As such further hydrophilic polymer in principle any polymer may be used that is suitable to provide a lubricious hydrophilic coating. In particular, suitable is such a polymer that is polymerisable, graftable and/or cross-linkable in the presence of a photo initiator.

Generally such hydrophilic polymer may have a number average molar mass in the range of about 1 000-5 000 000 g/mol. Preferably, the molar mass is at least, 20 000, more preferably at least 100 000. Advantageously, the molar mass is up to 2 000 000, in particular up to 1 300 000 g/mol. The molar mass is the value as determined by light scattering.

The polymer may for instance be a prepolymer, i.e. a polymer comprising one or more polymerisable groups, in particular one or more radically polymerisable groups such as one or more vinyl groups.

For providing a cross-linked network, a prepolymer having an average number of reactive groups per molecule of more than 1 is in particular suitable. Preferably, the average number of reactive groups is at least 1.2, more preferably at least 1.5, in particular at least 2.0. Preferably the average number of groups is up to 64, more preferably in the range of up to 15, in particular in the range of up to 8, more in particular up to 7.

However, also a polymer which is free of such polymerisable groups may be cured in the presence of a photo-initiator, in particular by the formation of grafts when the coating composition is exposed to light.

In preferred embodiment, the coating composition comprises at least one further hydrophilic polymer selected from the group consisting of poly(Preferably, the coating composition comprises at least one polymer selected from polyvinylpyrrolidone, polyethylene oxide (PEO/PEG) and polypropylene oxide.

In particular for polyvinylpyrrolidone (PVP) and polymers of the same class, a polymer having a molar mass corresponding to at least K15, more in particular K30, even more in particular K80 is preferred. Particular good results have been achieved with a polymer having a molar mass corresponding to at least K90.

Regarding the upper limit, a K120 or less, in particular a K100 is preferred. The K-value is the value as determinable by the Method W1307, Revision 5/2001 of the Viscotek Y501 automated relative viscometer. This manual may be found at www.ispcorp.com/products/hairscin/index_{—}3.html.

The concentration of the total of hydrophilic polymers, i.e. the total of the anti-microbial hydrophilic copolymer and any further hydrophilic polymer, in the (dry) coating is usually at least 1 wt. %, in particular at least 2 wt. %, preferably at least 10 wt. %, based upon the total weight of the dry coating. Usually the concentration is up to 90 wt. % although its concentration may be higher. Preferably, the concentration is up to 80 wt. %, in particular up to 70 wt. %, up to 60 wt. % or up to 50 wt. %.

In the coating, the presence of a polyelectrolyte (which may be a further hydrophilic polymer) is preferred for its beneficial effect on the dry-out time. The use of a compound capable of forming a radical upon radiation has in particular been found advantageous in improving the lubriciousness/dry-out time of a coating comprising a polyelectrolyte, in particular a coating comprising both a polyelectrolyte and a hydrophilic polymer mentioned above.

Herein a polyelectrolyte is defined as a polymer, which may be linear, branched or cross-linked, composed of macromolecules comprising constitutional units, in which between 5 and 100% of the constitutional units contain ionic or ionisable groups, or both. A constitutional unit may be a repeating unit, e.g. a monomer.

The polyelectrolyte preferably has a number average molar mass in the range of 1 000 to 5 000 000 g/mol, as determined by light scattering.

Examples of ionic or ionisable groups that may be present include amine groups, ammonium groups, phosphonium groups, sulphonium groups, carboxylic acid groups, carboxylate groups, sulphonic acid groups, sulphate groups, sulphinic acid groups, phosphonic acid groups, phosphinic acid groups and phosphate groups.

Preferably a polyelectrolyte is selected from the group consisting of (salts of) homopolymers and copolymers of acrylic acid, methacrylic acid, acrylamide, maleic acid, sulfonic acid, styrenic acid, fumaric acid, quaternary ammonium salts and mixtures and/or derivatives thereof.

If present, the concentration of the polyelectrolyte is usually in the range of 1 to 90 wt. %. Preferably it is at least 5 wt. %, in particular at least 10 wt. %. Preferably the concentration is up to 50 wt. %, more preferably up to 30 wt. %. The weight percentages are based upon the dry weight of the coating.

The polyelectrolyte is preferably present in combination with a hydrophilic polymer that is essentially free of ionic groups (such as PVP or another non-ionic/ionisable hydrophilic polymer mentioned above. Herein the other polymer may serve as a hydrophilic supporting network for the polyelectrolyte. An advantage thereof is an increased stability of the coating. In particular the tendency of the polyelectrolyte to leak out of the coating is thus reduced. Further, a combination of two or more of such polymers is advantageous with respect to both lubricity (in particular smoothness) and dry-out time.

The weight to weight ratio of polyelectrolyte to other hydrophilic polymer is preferably in the range of 1:90 to 9:1, more preferably 1:30 to 1:1, even more preferably 1:10 to 1:5.

Optionally, the coating composition according to the invention further comprises a cross-linker. The cross-linker may affect one or more properties of a coating prepared from the coating composition. In particular, it may contribute to the formation of a polymer network. Further, the cross-linker may help to form a coating with a reduced tendency to leach one or more components that should remain in the coating (such as a polyelectrolyte), out of the coating. Further, the attachment of the coating to the article may be improved.

A cross-linker usually is a compound which comprises two or more functional groups—such as radically polymerizable groups. Such radically reactive polymerizable groups may be selected from the group consisting of alkenes, amino, amido, sulfhydryl (SH), unsaturated esters, such as (meth)acrylates, unsaturated urethanes, unsaturated ethers, unsaturated amides, such as (meth)acrylamides, and alkyd/dry resins.

Particularly suitable are cross-linkers comprising vinyl groups. Such a cross-linker may be represented by the general formula G-(CR═CH₂)ₙ, wherein G can in principle by any moiety—in particular any optionally substituted hydrocarbon which may comprise one or more hetero atoms—to which vinyl groups can be bound, n is the number of vinyl groups, and R is hydrogen or a group selected from substituted and unsubstituted hydrocarbons which optionally contain one or more heteroatoms, in particular hydrogen or CH₃.

In one embodiment of the invention G is a residue of a polyfunctional compound having at least n functional groups, preferably chosen from the group consisting of polyethers, poly(meth)acrylates, polyurethanes, polyepoxides, polyamides, polyacrylamides, polyacrylics, poly(meth)acrylonics, polyoxazolines, polyvinylalcohols, polyethyleneimines and polysaccharides (such as cellulose, starch and the like) including copolymers thereof. G is more preferably an oligomer or a polymer comprising at least one polyethylene oxide and/or at least one polypropylene oxide. Such a polymer may contribute to reduced fouling of the coating, which may be beneficial with respect to an antimicrobial property of the coating. Particularly suitable are cross-linkers comprising at least one urethane group and at least one (meth)acrylate group, preferably a methacrylate group, i.e. urethane (meth)acrylates, preferably urethane methacrylates, because of their relatively high hydrolytic stability.

Because of the hydrolytic stability, the use of urethane (meth)acrylates or urethane (meth)acrylamides, also offers advantages in other hydrophilic coatings. The invention therefore also relates to a coating composition comprising a hydrophilic polymer, preferably chosen from the group of hydrophilic polymers defined above; a photo-initiator; a urethane (meth)acrylate or (meth)acrylamide, and a carrier liquid. The urethane (meth)acrylate or (meth)acrylamide may be any molecule comprising at least one urethane group and at least one (meth)acrylate or (meth)acrylamide group.

The cross-linker concentration may be chosen within wide limits, depending upon the intended result. In particular, it may be present in a concentration to provide a weight to weight ratio of the hydrophilic polymer to cross-linker in the range of 1:9 to 9:1.

Optionally one or more additives may be present in a coating composition according to the invention. Such additives may in particular be selected from antioxidants, surfactants, UV-blockers, stabilisers such as anti-sagging agents, discolourants, lubricants, plasticizers, organic antimicrobial compounds, pigments, and dyes. Such components may be selected from those known in the art, e.g. the prior art identified above. If present, the total concentration of such additives is usually less than 10 wt. % based on dry weight, in particular 5 wt. % or less.

Suitable antioxidants in particular include anti-oxidative vitamins (such as vitamin C and vitamin E) and phenolic antioxidants.

The surfactant may be an ionic (anionic/cationic), non-ionic or amphoteric surfactant. Examples of ionic surfactants include alkyl sulphates (such as sodium dodecylsulphates), sodium cholate, bis(2-ethylhexyl)sulphosuccinate sodium salt, quaternary ammonium compounds, such as cetyltrimethylammonium bromide or chloride, lauryldimethylamine oxide, N-lauroylsarcosine sodium salt and sodium deoxycholate. Examples of non-ionic surfactants include alkylpolyglucosides, branched secondary alcohol ethoxylates, octylphenol ethoxylates. If present, the surfactant concentration is usually 0.001-1 wt. %, preferably 0.05-0.5 wt. % of the liquid phase.

The coating composition further comprises a carrier liquid in a sufficient amount to disperse or dissolve the other components of the coating composition. The carrier liquid concentration is usually at least 68 wt. %, preferably at least 75 wt. %, more preferably at least 80 wt. %, even more preferably at least 85 wt. % of the total weight of the composition. In view of handling properties (low viscosity) and/or in order to facilitate the application of the composition such that a coating with the desired thickness is obtained, the amount of solvent in the composition is preferably relatively high. For that reason the total solids content is preferably 20 wt. % or less.

The carrier liquid may be a single solvent or a mixture. It is chosen such that the polymers can be dissolved or at least dispersed therein. In particular for dissolving or dispersing the hydrophilic polymer well, it is preferred that the carrier liquid is a polar liquid. In particular, a liquid is considered polar if it is soluble in water. Preferably it comprises water and/or an organic liquid soluble in water, preferably an alcohol, more preferably a C1-C4 alcohol, in particular methanol and/or ethanol. In case of a mixture, the ratio water to organic solvent, in particular one or more alcohols, may be in the range of about 25:75 to 75:25, in particular 40:60 to 60:40, more in particular 45:55 to 55:45.

As described above, the invention further relates to a method for coating an article and to a coated article. In principle, the coating composition can be used to provide any article with an antimicrobial coating. In particular, the coating composition may be used to coat an article and the article is a medical device. More in particular, the article may be intended for use in an orifice of a subject, such as the ear, the mouth, the nose or the urethral tract.

Preferred coated articles of the invention include catheters, endoscopes, laryngoscopes, tubes for feeding or drainage or endotracheal use or oesophageal use, guide wires, condoms, gloves, wound dressings, contact lenses, implants, extracorporeal blood conduits, bone screws, membranes (e.g. for dialysis, blood filters, devices for circulatory assistance), sutures, fibers, filaments and meshes.

The antimicrobial coating may be present on an inner surface (in case of a hollow article, such as a tube) and/or an outer surface. In view of providing an antimicrobial function, it is preferred that at least the surface or surfaces which are intended to be in direct contact with a body tissue and/or a body fluid are provided with the antimicrobial lubricious coating comprising the antimicrobial cross-linker according to the invention.

The surface to be coated can in principle be composed of any material, in particular of any polymer having satisfactory properties for the purpose of the article. Suitable polymers in particular include PVC, polytetrafluorethylene (PTFE, e.g. Teflon®), latex, silicone polymers, polyesters, polyurethanes, polyamides, polycarbonates, polyolefines, in particular ultra high molecular weight polyethylene, and the like.

If desired, the surface can be pre-treated in order to improve adherence of the antimicrobial coating, for instance a chemical and/or physical pre-treatment. Suitable pre-treatments are known in the art for specific combinations of materials for the surface of the article and the hydrophilic polymer. Examples of pre-treatments include plasma treatment, corona treatment, gamma irradiation, light irradiation, chemical washing, polarising and oxidating.

In an embodiment, the surface of the article is first provided with a primer layer, upon which the antimicrobial coating is applied to provide a coated article according to the invention. For instance, a primer layer as described in WO 06/056482, of which the contents with respect to the primer layer are incorporated herein by reference.

Application of the coating composition of the invention may be done by any methodology known by the person skilled in the art. Curing conditions can be determined, based on known curing conditions for the photo-initiator and polymer or routinely be determined.

In general, curing may be carried out at ambient temperature (about 25° C.) or below, although in principle it is possible to cure at an elevated temperature (for instance up to 100° C., up to 200° C. or up to 300° C.) as long as the mechanical properties or another property of the article and the coating are not adversely affected to an unacceptable extent. A reason for curing at an elevated temperature may be an improved adherence of the coating to the surface of the article.

Intensity and wavelength of the electromagnetic radiation can routinely be chosen based on the photo-initiator of choice. In particular, a suitable wavelength in the UV, visible or IR part of the spectrum may be used.

The invention will now be illustrated by the following examples.

### EXAMPLES

### Example 1

### Preparation of an Anti-Microbial Macromer

1.525 g (10 mmol) of vinylbenzyl chloride (VBC), 4.25 g (50 mmol) of methyl oxazoline (MO) and 0.166 g (1 mmol) of KI were dissolved in 50 ml acetonitrile in a three-neck flask under a nitrogen atmosphere. The mixture was heated until reflux and the polymerization was conducted for 6 hours. Subsequently 1.01 g (10 mmol) of triethylamine (TEA) was added. The heating was continued for another hour. The mixture was cooled down until room temperature and was extracted twice with 25 ml of water to remove the catalyst and some residual of the monomer. The polymer was isolated by removing the solvent by distillation. The polymer was analyzed by ¹H-NMR and by size exclusion chromatography (SEC). The number average molecular weight of the polymer was Mn=625 g/mol.

### Example 2

### Preparation of Anti-Microbial Macromer

0.76 g (5 mmol) of vinylbenzyl chloride (VBC), 1.5 g (10 mmol) NaI, and 4.25 g (50 mmol) methyl oxazoline were dissolved in 20 ml dimethyl formamide (DMF) in a two-necked flask under nitrogen atmosphere. The reaction mixture was heated at 90° C. and the polymerization was conducted for 4 hours. Subsequently 5.6 g (50 mmol) of triethyl amine was added. The reaction was continued for another two hours. The mixture was cooled down to room temperature and thereafter precipitated twice into cold diisopropyl ether. Finally, the product was dried under vacuum at 40° C., until all solvent was removed. Mn=1150 g/mol.

### Example 3-7

The preparation of the styrene derivative as described in Example 1 was repeated with various amounts of the reagents. The results are shown in table 1.

TABLE 1

| | VBC | MO | KI | | Mn |
|---|---|---|---|---|---|
| Example | (mmol) | (mmol) | (mmol) | TEA | (D) |
| 3 | 1 | 50 | 1 | 1 | 4250 |
| 4 | 3 | 50 | 1 | 3 | 1460 |
| 5 | 5 | 50 | 1 | 5 | 930 |
| 6 | 8 | 50 | 1 | 8 | 655 |
| 7 | 15 | 50 | 1 | 15 | 490 |

### Example 8

15.5 g (25 mmol) of the macromer of example 1, 111 g (1 mol) of N-vinylpyrrolidone and 1.5 g of AIBN (Acetobisisobutyronitril) were dissolved in 200 ml water in a 500 ml three neck flask, provided with a stirrer, a nitrogen inlet and a reflux condensor. The mixture was heated under nitrogen to 65° C. for 24 hours. Most of the water was removed by distillation, until a viscous liquid was obtained.

### Example 9

The polymer as obtained in example 8 was mixed with 1 wt % of benzophenone. A 25 μm thick coating of this composition was applied on a polyurethane test sheet of 5×5 cm and cured under UV light for 5 minutes.

Five of these samples were evaluated in the JIS Z2801 with Escherichia Coli bacteria (10⁷ CFU/ml). There was no bacterial growth detected.

1. Coating composition comprising an antimicrobial hydrophilic copolymer consisting of a macromer according to Formula 1, 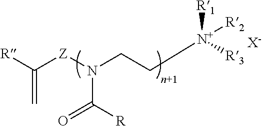
wherein R and R′ independently represent H or a group selected from substituted and unsubstituted hydrocarbons which optionally contain one or more heteroatoms, preferably a C1-C20 hydrocarbon, more preferably a C1-C20 alkyl or aryl, R″ is
H or CH₃, Z is benzyl, CO or 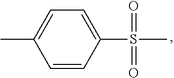
X═I, Br, Cl, CF₃SO₃, C₆H₄SO₃, n=1-100 and a comonomer.

2. Coating composition according to claim 1, wherein the comonomer is N-vinylpyrrolidone.

3. Coating composition according to claim 1, comprising a further hydrophilic polymer.

4. Coating composition according to claim 1, wherein the further hydrophilic polymer is selected from polyvinylpyrrolidone, polyethylene oxide (PEO/PEG) and polypropylene oxide.

5. Coating composition according to claim 1, further comprising a photo-initiator.

6. Coating composition according to claim 1, further comprising a polyelectrolyte.

7. Coating composition according to claim 1, further comprising a cross-linker.

8. Use of a coating composition according to claim 1 in a medical application, in particular in a medical device.

9. Use of a coating composition according to claim 1 in the manufacture of a medical device for the treatment of a disorder selected from the group consisting of complications of the urinary tract, complications of a cardiovascular vessel, kidney infections, blood infections (septicemia), urethral injury, skin breakdown, bladder stones and hematuria, or to prevent infections.

10. Use of a coating composition according to claim 1 or a coating obtainable by curing a coating composition as an antimicrobial agent.

11. An article comprising a coating composition according to claim 1.

12. An article according to claim 11, wherein the article is a medical device, preferably selected from catheters, endoscopes, laryngoscopes, tubes for feeding or drainage or endotracheal use, guide wires, condoms, gloves, wound dressings, contact lenses, implants, extracorporeal blood conduits, bone screws, membranes (e.g. for dialysis, blood filters, devices for circulatory assistance), sutures, fibers, filaments and meshes.
